(19) United States
(12) Patent Application Publication
(10) Pub. No.: US 2002/0059377 A1
(43) Pub. Date: May 16, 2002

(54) Collaborative computing systems using dynamic computing environments

(76) Inventors: Jagadish Bandhole, San Jose, CA (US); Sekaran Nanja, San Jose, CA (US); Shan Balasubramaniam, Mountain View, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/888,110

(22) Filed: Jun. 22, 2001

Related U.S. Application Data
(60) Provisional application No. 60/249,028, filed on Nov. 14, 2000.

(51) Int. Cl. G06F 15/16

(52) U.S. Cl. 709/204; 709/217

(57) ABSTRACT

A system and method for providing collaborative computing is provided. Resources can be allocated through a first user interface in a dynamic computing environment (“DCE”). A process can then be executed using the allocated resources and information from the execution of the process can be transferred to the first user interface. The same information can also be transferred to a second user interface. Additionally, control over the allocated resources and control to modify the information can be switched between the first and second user interfaces. The system and method can also be applied to a distributed, interactive training system, an interactive, real-time, technical support model, and a usability study model.

### CROSS-REFERENCES TO RELATED APPLICATIONS

The present application claims the benefit of priority under 35 U.S.C. § 119 from the provisional patent application, U.S. Provisional Patent Application No. 60/249,028, filed on Nov. 14, 2000, which is hereby incorporated by reference as if set forth in full in this document.

This application is related to U.S. Non-Provisional Patent Application entitled “User Interface for Dynamic Computing Environment Using Allocateable Resources” Ser. No. 09/663,252 filed on Sep. 15, 2000, page no. 1-27, FIGS. 1-5, U.S. Non-Provisional Patent Application entitled “System for Configuration of Dynamic Computing Environments Using a Visual Interface” Ser. No. 09/662,990 filed on Sep. 15, 2000, page no. 1-23, FIGS. 1-2, and U.S. Non-Provisional Patent Application No.______ (Attorney Docket No. 202706-000300U.S.) filed on May 17, 2001 entitled “Dynamic Computing Environment Using Remotely Allocable Resources”, which are hereby incorporated by reference, as if set forth in full in this document, for all purposes.

### BACKGROUND OF THE INVENTION

The present invention relates in general to digital processing and more specifically to a system that enables collaborative computing using dynamic computing environments.

The growth of communications industry has resulted in many models of distributed and interactive computing (“Collaborative computing”) where multiple users can participate concurrently in a single computing process. All prior art systems that enable Collaborative computing are restricted to specific hardware/software platforms, impose restrictions on users' control over the computers involved, or are limited to distributing multiple copies of the same information. The following description provides different background scenarios where prior art collaborative systems have been used with limited success.

The training and education industry has been revolutionized by the use of computers to develop, distribute, and deliver course material. In particular, the use of “hands-on” or interactive training with graphical tools and simulated subject models has created new avenues of teaching. But, a truly “distributed” classroom or laboratory has not been realized, as yet, because of the inherent limitations in frameworks available for communication between the course instructor and students. Furthermore, a course instructor and students may not be situated in a single place and they may not all own the same computers and/or have the same software.

Some prior art systems have been developed to allow computer users in one location, such as instructors, to be able to share information with other users, such as students. This allows the instructor-in a location that is remote from a student-to assist and educate the student. For example, a student who is learning to program computers will often encounter a puzzling error in a program that was written. During the programming process, the instructor may wish to watch how the student is compiling, or building, the program to see what errors are generated by different processes used by the student. For example, processes can include a text editor, compiler, linker, debugger, or other applications or executable instructions.

The instructor would also be interested in various other processes executing on the user's computer, such as an executable program that the student has written. Each of the processes can be very complex and can result in a lot of information being output on the display. Also, many specific, detailed, and intricate interactions with the user are often required by the processes. Prior art systems can provide rudimentary “information sharing” so that an instructor can view the information displayed on a remote student's computer. The instructor can also communicate with the student, take partial control of the student's computer, and perform other information sharing actions to assist and educate the student.

FIG. 2 illustrates a prior art approach to information sharing between computers. Typically, an instructor, as indicated by USER1, operates a personal computer (PC) 10 that communicates with USER2's PC 14 over a digital network such as Internet 12. Note that any type of network, or inter-computer communication can be employed.

USER1 needs to control, or otherwise interact with, an application program, such as application 20, executing on USER2's PC. The prior art uses additional programs, which are often identical processes created by a common manufacturer, to allow interaction of USER1 with the application 20. These are referred to as monitor processes 22 and 24.

Monitor process 22 can intercept displayed information sent from application 20 to USER2's PC display device (i.e., a computer monitor). Monitor process 22 transmits the displayed information via Internet 12 to monitor process 24 in USER1's PC. Monitor process 24 can display the transferred information on USER1's display screen so that an instructor using PC 10 can view the same information that is presented to a student at PC 14.

In a similar manner, keyboard, mouse, or other control signals can be transferred from USER1's PC via monitor process 24, the Internet 12, and monitor process 22, to control application 20.

Although the prior art system as illustrated in FIG. 2 does provide a degree of interaction via a user in one location of a process being executed by a second user in a remote location, this approach has drawbacks.

For example, the accuracy of the interaction is only as good as the monitor process executing on each machine. That is, USER2 can, and often does, interact directly with the application 20 while the monitor process 22 typically only intercepts, and can control, portions of information relevant to application 20. Thus, USER1 does not have fall interaction with, or control of, the application 20.

Another problem with the prior art approach is that different computers may be used by each of the users. This means that hardware and software present in USER2's PC is often not present in USER1's PC. Because of the complexity of hardware and software systems, any process executing in a particular system, or a platform, is highly affected by the specific configuration of the hardware and software in the platform. This means that an application executing on one user's platform might produce results that are not reproducible on a second user's platform. The relevance of this to the prior art of FIG. 2 is that even monitor processes such as 22 and 24 will not necessarily operate the same way on different platforms. Thus, results are unpredictable and inaccurate.

Another drawback of the prior art system is that a remote user wishing to obtain control of another computer never really obtains fall control of the user's system. In an example of FIG. 2, USER1 never obtains full control, or even a substantial control, of USER2's overall system. This makes intricate problems, such as would be encountered in a computer programming training class, very difficult to resolve when an instructor is not present, locally, with the student.

Additionally, problems in collaborative computing can occur in a technical support scenario. The usage of computers and other computing devices has become widespread, and with the development of the Internet, computers have become essential in the everyday lives of people. Additionally, more powerful and complex computers have been developed allowing users to complete a multitude of tasks in a shorter amount of time. Further, newer and more complex applications and software have been developed that allow users to utilize computers in even more of their everyday lives. With the increase in complexity of computers and applications, errors and problems with the computers and applications have become more commonplace. For most computer-related errors and problems, a user will not be able to fix the problem themselves. Therefore, calls to remote customer support providers have to be made.

In most cases, the user calls the support provider over the telephone and has to explain the problem over the phone. The support provider would then have to analyze the problem without seeing exactly what was wrong and verbally try to talk the user through the problem. This approach is usually not effective because problems can be complex and a user's limited knowledge of the computer or software does not allow the user to adequately describe the problem to the support provider or allow the user to fix the problem with direction from the support provider. In other cases, a user may email a problem to the support provider and receive an email response detailing a solution if possible. However, this approach is even worse because most problems need to be solved interactively or immediately.

Another approach to customer support can use the above described prior art approach. For example, a user, such as USER2, could incur errors to application 20. The USER2 could then demonstrate the problem on USER2's computer and a support provider, such as USER1, could view the problem on USER1's computer. USER1 may then verbally describe a solution to USER2. Also, USER1 may try to demonstrate a solution to USER2. However, the ability to demonstrate the problem to USER1 depends on USER2 containing the appropriate software and hardware allowing USER1 to view USER2's problems. Further, because USER1 does not have full control, or interact with the application 20, USER1 may not be able to replicate the error and thus, a solution cannot be shown on USER2's computer. In prior art systems, USER1 cannot fix the problem with application 20 directly. USER1 can only instruct USER2 on how to fix the problem. Therefore, while the support provider may be able to view the problem directly, the difficulties of fixing the problem have not been changed because the provider must still direct the user to solve the problem themselves.

Further, usability studies also incur problems with prior art collaborative computing systems. In the development of computer software and hardware, many producers conduct usability studies to enhance the development process. Usability studies can be used for two different purposes, such as for “user testing” and for“user behavior modeling”. “User testing” involves testing of a specific product by end users to measure the usability of the product. “User behavior modeling” involves identifying individual user behavior with respect to a class of products and generalizing the behavior to arrive at a model for aggregate user behavior or to arrive at patterns for the behavior. These models or patterns can in turn be used in designing new products.

For instance, in the “user testing” case, one or more users are asked to interact with a software system or a hardware system. While users are interacting, those who conduct the study monitor the interaction of the users. Watching the interactions in real-time may lead to discovery of defects or limitations in the system, particularly with respect to its interactivity.

Typically users are brought into labs where the system has already been set up for testing. Those who want to monitor either sit with the users or stand behind them to watch the interaction. Alternatively, monitoring can be done by a video camera set up to watch the users. Both of these approaches are intrusive, i.e., users are physically aware of being watched, which results in unnatural behavior, thus skewing the results of the test. In other systems, additional software can be used to record users' on-screen interactions, such as the information typed in by the user or mouse-clicks. However, the recording does not completely track the user's activity and in particular, does not record the sequence of interactions by the users and the responses of the system in a precise order. Furthermore, the monitors conducting the study cannot interact with the system or help the user unless the monitors are physically present with the users.

Thus, it is desirable to provide a system that allows a user in one location to comprehensively and efficiently interact with, observe, and/or control a process, or hardware, in a computer at a remote location to a degree that is not provided by the prior art.

### BRIEF SUMMARY OF THE INVENTION

A system and method for providing collaborative computing is provided by virtue of the invention. In one embodiment, resources can be allocated to a first user interface in a dynamic computing environment (“DCE”). An application can then be executed using the allocated resources and information from the execution of the application can be transferred to the first user interface. The same information can also be transferred to a second user interface. Additionally, control over the allocated resources and control to modify the information can be switched between the first and second user interfaces. The system and method can also be applied to a distributed, interactive training system, an interactive, real-time, technical support model, and a usability study model. Accordingly, in one embodiment, a method for collaborative computing in a system including a dynamic computing environment, at least one resource in the dynamic computing environment, a first user interface and a second user interface is provided. The method comprises: allocating resources of the dynamic computing environment through the first user interface; sharing the at least one resource between the first user interface and the second user interface; executing an application on the at least one allocated resource using either the first user interface or the second user interface; transferring information generated by execution of the application to the first user interface; and transferring the information generated by execution of the application to the second user interface in response to a command to collaborate with the second user interface.

In another embodiment, a method for providing sharing of a software process among multiple users, the method using a resource computer executing the process in a first location, a first user computer operated by a first user in a second location and a second user A computer operated by a second user in a third location comprising: using the resource computer to transmit information about the execution of the process to the first user computer, and using the resource computer to transmit information about the execution of the process to the second user computer is provided.

Further, in another embodiment, a system for sharing a software process among multiple users comprising: a dynamic computing environment, a resource computer in the dynamic computing environment that executes the process and transmits information about the process, a first user computer in a second location configured to receive information about the execution of the process, and a second user computer in a third location configured to receive information about the execution of the process is provided.

A further understanding of the nature and advantages of the invention herein may be realized by reference of the remaining portions in the specifications and the attached drawings.

### BRIEF DESCRIPTION OF THE DRAWINGS

FIG. 1 illustrates an approach of the invention to information sharing between computers.

FIG. 2 illustrates a prior art approach to information sharing between computers.

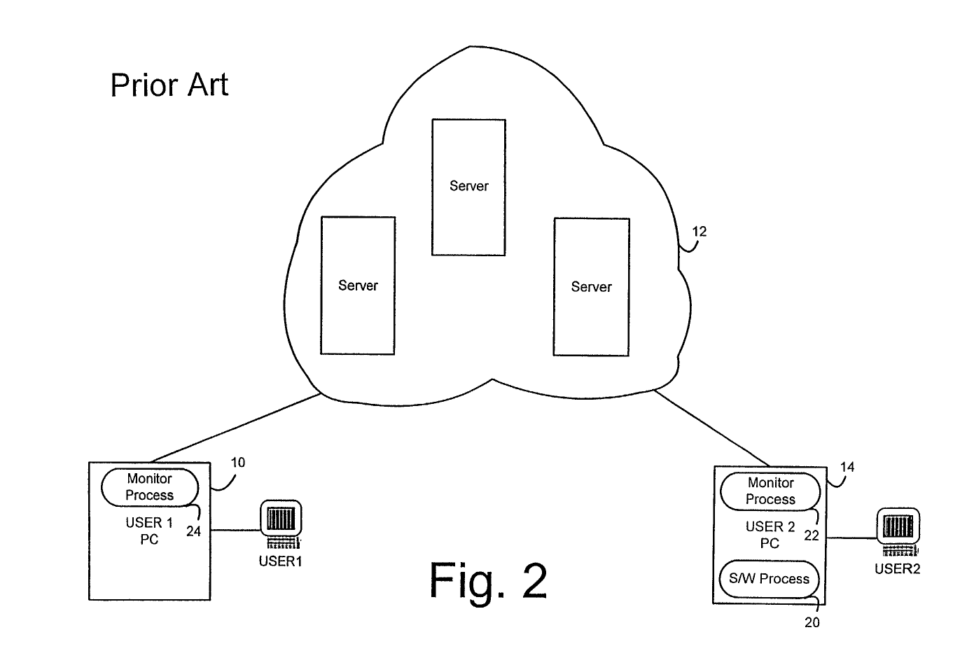

### DESCRIPTION OF THE SPECIFIC EMBODIMENTS

One embodiment of the present invention allows fast, efficient selection and configuration of processing networks, which can then be accessed and managed remotely. The processing network is referred to as a system including “resources.” A system resource is any hardware, software, or communication components in the system. For example, discrete hardware devices include processing platforms such as computers or processors, mobile/laptop computers, embedded computing devices, hand-held computers, personal digital assistants, point-of-sale terminals, smart-card devices, storage devices, data transmission and routing hardware etc., without limitation. Additionally, computer peripherals such as monitors, input/output devices, disk drives, manufacturing devices, or any device capable of responding to, handling, transferring or interacting with digital data are also resources. Software, or any other form of instruction, is executed by processors in the system and is also a type of resource. Finally, communication resources are also part of the system such as a digital network's hardware including the network's configuration and topology, where control of the network is provided by software and/or hardware. Additionally, the network may be based on wired connections or wireless connections. For instance, the network hardware and software may be based on Bluetooth wireless standards.

For example, a processing network of a general consumer might include a PDA and a cell phone, each connected by wireless channels to a single personal computer, which in turn is connected to an email server at a remote location through the Internet. As another example, a processing network might include a personal computer running Microsoft Windows 98 operating system, a lap-top computer running Linux operating system, and another personal computer running Windows NT operating system along with router and firewall software, wherein all three computers are connected using a local Ethernet hub, and the router software routes connections to the Internet.

According to an embodiment of the present invention, the resources for such a processing network are fully selectable and allocable by a system architect. In a specific embodiment, a primary company, Jareva Technologies, Inc.® provides proprietary technology to a system architect for designing a system by allocating resources and specifying how the resources are to be used. The system architect can be an individual, corporate entity, etc. The system is referred to as an “environment”—or more specifically as a “computing environment” and the primary provider of such an environment is referred to as an Environment Service Provider (ESP). A typical system architect is referred to as the “customer.” The primary provider obtains revenue for providing the resources and the tools to easily select, allocate, configure and run the environment.

The specific embodiment of the present invention allows fast allocation and configuration of resources such that different environments can be created from the same resources within minutes, or even seconds. This allows “time sharing” of overall resources so that a first environment can be “alive” or operative for a time period defined by the system architect (e.g., daily two-hour slot), followed by second, third and fourth environments being instantly created for the next four hours for three different customers, and so on. After a time period expires, such environments might either manually or automatically de-allocate such resources. Since these “computing environments” can be dynamically configured and reconfigured out of the same set of resources, these will also be referred to as “Dynamic Computing Environments”.

In particular, environments without any computing devices i.e., environments made only of networks, will also be referred to as “virtual networked environments” or simply as “virtual networks”.

A specific embodiment allows customers to create a computing environment from a remotely-accessible user interface such as a web page on the Internet. Thus, the customer can create, modify and operate the environment from anywhere in the world. Since the resources, in turn, can communicate over networks, including the Internet, this approach eliminates the cost of shipping hardware and software. Hardware and software designers, programmers, testers or other personnel using an environment according to the present invention can, similarly, be located anywhere in the world such that labor costs are optimized.

The creation of dynamic computing environments (“DCE”) is automatic. For example, a customer can request a web-site simulator using twelve web-page servers on a Microsoft® NT platform, two disk arrays at a specific bandwidth and storage capacity, two caching servers and 200 clients running Netscape Navigator™ under Microsoft Windows™ 2000 using Pentium III™ processors at under 800 MHz. Such an environment is created and destroyed, and even re-created automatically, without human intervention each time. Unlike the conventional computing infrastructure, according to an embodiment of the present invention there is no need to physically couple or de-couple, each physical machine or resource to each other upon adding or removing such resources. There is no need to set-up Internet Protocol (IP) addresses or other network settings, or install operating systems and associated application programs on one or more physical machines. All such activities on a DCE can be performed automatically without user intervention.

According to an embodiment of the present invention, the DCE is a virtual computing system including a network comprising a number of distinct types of machines and a network connecting them. For example, a system architect might require a DCE to include a Sun Sparc running a certain version of Solaris O/S coupled to a Linux machine. The present invention enables the separation of the activity of designing a DCE, from the activity of actually creating the DCE. Designing a DCE includes choosing the specific hardware, choosing the operating systems or other software, and choosing the specific interconnections, etc. Creating a DCE includes allocating the resources, installing the operating systems and other software, etc. Furthermore, the present invention automates the process of creating the DCE. A DCE for which resources have not been allocated yet will also be referred to as a virtual computing environment. Similarly, a computing device (or a subnet) that is part of a DCE will also be referred to as a virtual computing device (or a virtual subnet), if the required resources for the computing device (or the subnet) have not been allocated yet.

An embodiment of the present invention provides a framework that enables configuring, and provisioning DCEs remotely. Configuring a DCE involves choosing the resources and their interconnections. The present invention supports operations for making such design choices through appropriate programmable interfaces. The interfaces can be used interactively through a graphical user interface such as a web page or non-interactively through a program script. Provisioning a DCE involves allocation of physical resources required for a DCE to function. The present invention manages the physical resources needed for provisioning DCEs and supports operations for allocating/de-allocating these resources. In one embodiment of the present invention, the framework for provisioning DCEs is implemented as a distributed system consisting of different software programs running on different computers and networking hardware. In a further embodiment, the present invention permits “virtual” hosting of dynamic computing environments. As used herein, the term “virtual” specifies that neither the requisite devices nor the network need to be physically accessible to users. Further, in accordance with this embodiment, the hosting process may be initiated or terminated by users at will, from any geographic location. Thus the administrative framework allows users to remotely configure and provision DCEs.

A further understanding of embodiments of the present invention will be gained with reference to the diagrams and the descriptions that follow.

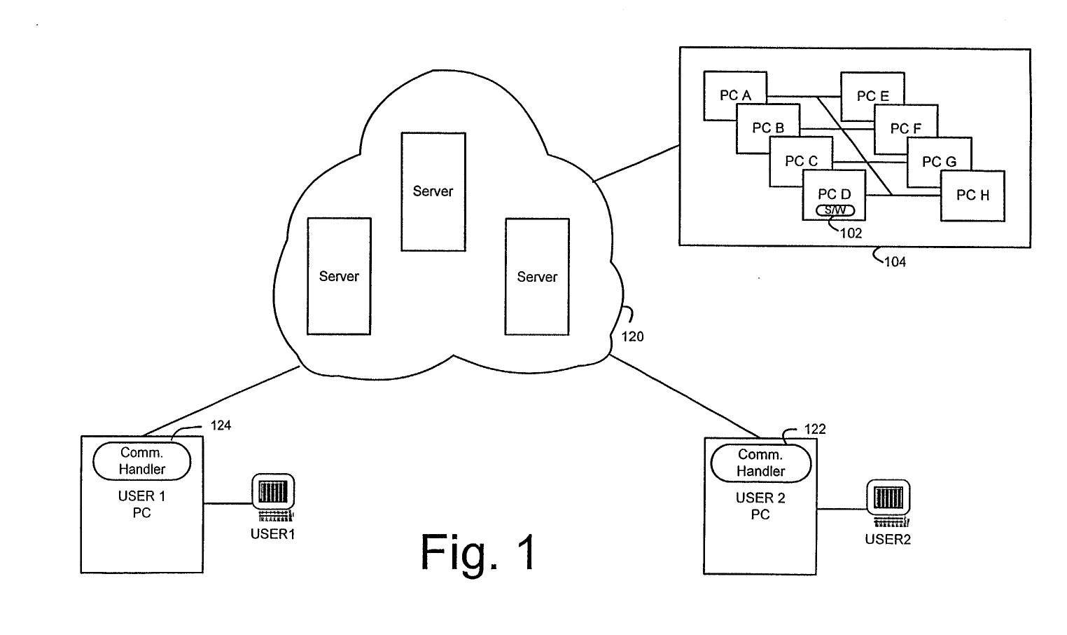

In FIG. 1, a USER1 PC, USER2 PC, and a dynamic computing environment (“DCE”) 104 is shown. The USER1, USER2, and DCE are interconnected through a digital network 120, such as the Internet.

The DCE 104 includes any number, type, and configuration of hardware components and software processes. For example, a user, or a group of users, can be allocated an International Business Machines (IBM) compatible PC (such as PC D) having an Intel processor, running a Microsoft operating system, having random-access memory (RAM), hard disk storage, etc. Software process 102 is also running within the PC of the DCE. Note that any arbitrary user can be allocated any combination of resources.

USER2 can be local to the DCE but will typically be located in a remote location from the physical DCE and communicates with the allocated resources via a digital network such as Internet 120. Communications handler 122 can be dedicated software to allow USER2 to interact with the allocated resources and with software process 102. Communications handler 122 can also be, e.g., a web browser, operating system, or other means of interfacing and control. In some cases, communications handler 122 is not needed. For example, USER2 can communicate with the DCE via communications hardware and software at the DCE (not shown in FIG. 1) so that USER2 may not even need a PC but can use a “dumb” terminal, or limited device such as a personal digital assistant (PDA), palmtop computer, web-enabled cell phone, etc.

USER1 can be local to the DCE but will typically be located in a remote location from the physical DCE and communicates with the allocated resources via a digital network such as Internet 120. USER1 includes a communications handler 124, which can include the same properties as communications handler 122. USER1 can also include the same properties as described above for USER2. Additionally, USER1 can be local to USER2 or can be located in a remote location from the physical USER2 PC.

Software process 102 can be any type of application program, applet, operating system, plug-in, user-interface controller, or other process. Also, more than one user can use the allocated resources of the DCE at one time. For example, the DCE can support an entire classroom of students, where each student can be at a separate computer, or terminal, at separate locations. An instructor, or administrator, can configure, or allocate the resources to allow different students to accomplish different tasks, or lessons. For example, one student can be configured with a PC application while another is configured with a workstation and development tools.

USER1 and/or USER2 are able to execute, or have other interaction with, software process 102. However, software process 102 is not resident at USER1 or USER2's PC. Instead, software process 102 resides in DCE 104. USER1 can also contain software processes allowing USER1 to allocate resources in the DCE. For example, a user interface as disclosed in “User Interface for Dynamic Computing Environment Using Allocateable Resources” Ser. No. 09/663,252 filed on Sep. 15, 2000 and U.S. Non-Provisional Patent Application entitled “System for Configuration of Dynamic Computing Environments Using a Visual Interface” Ser. No. 09/662,990 filed on Sep. 15, 2000 can be used by USER1 to allocate resources. USER1 can then allocate and configure various resources for USER2. Additionally, USER1 can re-allocate and re-configure the various resources when needs change or different applications need to be run. Also, it should be understood that USER2 can also allocate resources in the DCE. Further, control to allocate and configure resources can be switched between USER1 and USER2. Also, either USER1 or USER2 can have priority in allocating and configuring resources. Thus, the user that has priority can send a command overriding any other user's control to allocate resources.

Once the resources have been allocated, USER1 and/or USER2 can interact with software process 102. For example, USER2 can interact with software process 102 and receive information related to the interaction. USER2 can also modify the information and further interact with software process 102. Additionally, USER1 may wish to monitor or control USER2's interaction with the software process 102. USER1 can then send a command to cause interface and control information to be transferred to USER1's PC. In other words, USER1 may receive the same information or view the same screen as shown on USER2's PC. USER1 can also send a command limiting USER2's control, or access, to software process 102. For example, USER2 may be only given viewing rights and not control rights. In contrast, USER2 can also send a command requesting control or access of the software process 102. In order to avoid conflicts, a priority system can be set up where either USER1 or USER2 will receive control or access over the other user. For example, a command from USER1 would cause USER2 to lose control until USER1 signaled control should be given back to USER2. Thus, control of the software process 102 and control of which user PC can modify the information received is enabled.

Therefore, USER1 and USER2 can gain control over the identical resources. This eliminates inherent problems caused by having different users operating different computing systems while trying to access or share the same resource. Eliminating the inherent problems provides advantages when applied to models such as a distributed training system, an interactive, real-time, technical support for computing devices system, and a usability study system.

In one embodiment, a distributed interactive training system that enables course instructors to quickly create remotely accessible virtual classrooms or labs, provides for remote on-screen interactivity between students and the course instructor, and also enables the course instructor to interactively monitor on-screen activities of students. Each course instructor can quickly create a computer configuration with hardware of their own choice and running the operating systems and applications they require. Then, course instructions can easily copy these configurations and create a dynamic computer environment that will act as a virtual classroom with one computer per person (student or course instructors).

An instructor, such as USER1, can create a virtual classroom for a student, such as USER2. It should be understood that additional students or additional instructors can be added, such as a USER3 (not shown). The instructor can allocate resources in the DCE for the students of the class. The same machine and operating system can be allocated for all students of the class or different variations of machines and operating systems can be allocated for different students. For example, an IBM compatible PC running a Microsoft operating system can be allocated to USER2 and a UNIX machine running on a Sun Solaris machine could be allocated to USER3. Thus, multiple students with different resource requirements can be handled with the resources provided by a single DCE. The allocated resources can then include a single allocated resource to be shared by all the students of the class, can include one allocated resource for each student, and/or one allocated resource shared by a group of one or more students. Once the DCE has been configured and set up, the allocated resources can be accessed by either the instructor or the students. In one embodiment, communication handler 122, communication handler 124, or the communication handler of any additional users can be used to access the software process running on the DCE. However as noted above, use of a communication handler is not necessary.

In one embodiment, USER1 can interact with software process 102. Additionally, copies of the output of the software process 102 can be viewed remotely from different input/output devices, such as USER1 or USER2. Thus, USER1, USER2, and the DCE can all be in remote locations while the respective computers communicate over the Internet or other digital network. In one embodiment, USER1, or the instructor, can interact with software process 102 by editing information shown on the screen or executing different applications using software process 102. As information is modified or commands are executed, the students, such as USER2 and USER3, can view the modifications or results of the executed applications in real-time on their computers.

Additionally, the students can interact with software process 102 and the instructor can view the various actions of the students. For example, USER2 can modify information as viewed on the USER2 PC, interact with software process 102, or execute applications located on the allocated resources. As USER2 performs these tasks, USER1 can observe all of these activities on USER1's PC. Thus, USER1 can track the progress of each student, further instruct the student, or verify if the student is proceeding in the correct way. The instructor can also view each different user or student of the classroom in separate windows.

The instructor can be provided with controls, e.g., in a graphical user interface, where the instructor can grant or control access rights to students. Thus, the instructor can obtain any desired level of control over the students' display. For example, the instructor can send a command to software process 102 allowing the student to have control of the software process 102. Additionally, a student's access to and control of software process 102 can be limited. For example, USER2 may temporarily be given only viewing rights and not control rights. Additionally, priority can be given so that either the instructor's or student's signal for control can override the other user's signal for control. Also, the priority system can allow an instructor to take control of a student's computer at any time. Additionally, control of software process 102 can be switched between the instructor and student. Thus, the student and instructor can interact between their shared views in real-time. This interaction can take place without disturbing the rest of the class by an instructor only taking control of the one student's view and then giving control back to the one student's view.

Additionally, the instructor can also allocate additional resources or remove resources from a student's configuration. For example, a first lesson can be with an IBM compatible PC using an application such as Excel, and a second lesson can be with a UNIX machine such as a Sun Solaris machine using an application such as X windows. Thus, the lessons can all be done with the instructor and student using the same computer while traditionally a student would have to switch from a PC to a Unix machine to receive both lessons.

Note that, unlike the prior art, the instructor in FIG. 1 (USER1) obtains control of the identical resources (i.e., platform and environment including the native user interface) that USER2 had been using. Thus, differences in local hardware between USER1 and USER2 have been minimized or circumvented. In many types of education it is important for the instructor to have an identical system, as errors can be dependent on minute characteristics of hardware, software, or a combination of both.

In another embodiment, a collaborative model of technical support is provided. Using the DCE, a computer system can be supported remotely in an interactive mode in real-time. In one instance, a consumer, such as USER2, can be allocated resources in the DCE. When problems related to an application on the allocated resources or the actual allocated resources occur, the consumer can call a customer support provider, such as USER1. The support provider can then access the exact resources the consumer is using and also simultaneously access a copy of the consumer's desktop screen (“view”). Once viewing the problem, the support provider can diagnose or analyze the situation and demonstrate a solution on the screen of USER2's PC. Additionally, the support provider can fix the problem in real-time directly on the allocated resources because the provider has direct access to the exact resources the consumer was using. The instructor may also allocate different resources to the consumer allowing the consumer to access error-free resources.

Additionally, the support provider can create multiple copies of the user's desktop screen and make these copies accessible to other support staff. The support provider can also make some, all, or none of the view's modifiable by the other support providers. If, during the explanation of the error, another support provider figures out the solution, the first support provider can switch the second support provider's view to be modifiable and/or also grant access to the allocated resources to the second support provider. The second support provider can then fix the problem or demonstrate an on-screen solution to the other support providers and the consumer.

Thus, the support provider is granted access and obtains control of the identical resources the consumer is using. Therefore, the consumer can receive solutions much faster than if the user had just described the problem over the telephone and had been told what to do. Effectively, the problems can be fixed by the support staff or the consumer can be shown on the screen of the consumer's computer how to fix the problem.

Additionally, control can be switched between the consumer and support provider. Thus, the support process can be iterative with the consumer and support provider both accessing the allocated resources as necessary to solve the problem.

In one embodiment, a collaborative model for usability studies using the DCE is provided. In a usability study, a user, such as USER1, can monitor on-screen activities of a user, such as USER2, in real-time. USER1 can allocate and configure resources in the DCE that can be reviewed remotely from different input/output devices, such as USER2. The different views can be controlled so that only one of the views is modifiable at a time or different views can be switched to be modifiable at various times. The USER2 can then be provided with a study where USER2 is required to interact with a view provided on their computer. The DCE can be configured so that what is written in USER2's view is viewable in real-time on USER1's PC or view. Thus, monitoring by USER1 can be done and if desired, USER1 can take control of software process 102 or the allocated resources and interact with USER2. Additionally, USER1 does not have to be in the same location and can be located remotely from USER2. Thus, feedback obtained from ‘user testing’ of software is immediate and accurate as opposed to prior art systems where those who conduct the study (USER1) have to personally monitor the participant(s) such as USER2, in an intrusive way or have to forego accuracy by using automated monitoring systems that are incomplete or imperfect. Also, user behavior during software interaction can be measured using the DCE.

Another example can provide reliability to a study using multiple users. The multiple users in the study can be monitored using the USER1 screen and USER1 can interact with and help the participants that are having trouble with software process 102 or users who are experiencing a system failure. Thus, the reliability of usability study is increased because problems during the time of the study can be immediately addressed. Also, multiple remote users can be involved in the study without involving multiple monitors. Additionally, the participants in the study do not need resources (like hardware or software) to participate because any resources required are remotely allocated by those who conduct the study.

For instance, an e-commerce company may need to test the usability of its new shopping-cart system. In prior art systems, the company would bring in users to their labs for testing. If the lab can handle 10 users at a time and 2 researchers are needed to oversee the users and the company wants to test the system with 100 users, the company would bring in 10 batches of 10 users each. The users would then use the shopping-cart system in the lab and give feedback to the researchers. The researchers would monitor the users' behavior and model the usage patterns to evaluate the usability of the system.

However, using an embodiment of the present invention, the company can use the system for adding more resources because users do not need to come to the lab for testing. The company can allocate resources for any number of users at one time and the 2 researchers can monitor and record the behavior of the users from their office. For example, resources can be allocated for 50 users or 100 users. Thus, the users do not need to travel to the lab, and are not bothered by someone watching over their shoulders, which can provide more accurate results. The researchers can share different views of the same consoles or screens of the users if they need to interact with the users or need to help them out. It is also possible to have flexible scheduling of users because the DCE enables allocation and reallocation of resources.

The above description is illustrative but not restrictive. Many variations of the invention will become apparent to those skilled in the art upon review of the disclosure. For example, many users can be included in addition to USER1 and USER2. The scope of the invention should, therefore, be determined not with reference to the above description, but instead should be determined with reference to the pending claims along with their full scope or equivalence.

What is claimed is:

1. A method for collaborative computing in a system including a dynamic computing environment, at least one resource in the dynamic computing environment, a first user interface and a second user interface, the method comprising:
allocating resources of the dynamic computing environment through the first user interface;
sharing the at least one resource between the first user interface and the second user interface;
executing an application on the at least one allocated resource using either the first user interface or the second user interface;
transferring information generated by execution of the application to the first user interface; and
transferring the information generated by execution of the application to the second user interface in response to a command to collaborate with the second user interface.

2. The method of claim 1, further comprising modifying the information in the first user interface by interacting with the at least one shared resource through the first user interface.

3. The method of claim 1, further comprising modifying the information in the second user interface by interacting with the at least one shared resource through the second user interface.

4. The method of claim 1, further comprising switching control to modify the information between the first and second user interface.

5. A method for providing sharing of a software process among multiple users, the method using a resource computer executing the process in a first location, a first user computer operated by a first user in a second location, and a second user computer operated by a second user in a third location, the method comprising:
using the resource computer to transmit information about the execution of the process to the first user computer; and
using the resource computer to transmit information about the execution of the process to the second user computer.

6. The method of claim 5, further comprising controlling the resource computer with the first user computer.

7. The method of claim 5, further comprising controlling the resource computer with the second user computer.

8. The method of claim 5, further comprising switching control of the resource computer between the first and second user computers.

9. The method of claim 5, further comprising modifying the information using the first user computer.

10. The method of claim 5, further comprising modifying the information using the second user computer.

11. The method of claim 5, further comprising switching control to modify the information between the first and second user computer.

12. The method of claim 5, wherein the shared software process is an operating system.

13. The method of claim 5, wherein the shared software process is a user interface controller.

14. The method of claim 5, further providing for sharing of a plurality of software processes.

15. The method of claim 5, wherein the system is used in training.

16. The method of claim 5, wherein the system is used in technical support.

17. The method of claim 5, wherein the system is used in usability studies.

18. A system for sharing a software process among multiple users, the system comprising:
a dynamic computing environment;
a resource computer in the dynamic computing environment that executes the process and transmits information about the process;
a first user computer in a second location configured to receive information about the execution of the process; and
a second user computer in a third location configured to receive information about the execution of the process.

19. The system of claim 18, wherein the dynamic computing environment is remotely located from the second and third location.

20. The system of claim 18, wherein the second location is remotely located from the third location.

21. The system of claim 18, further comprising a user interface controller, wherein the user interface controller switches control of the resource computer from the first user computer to the second user computer.

22. The system of claim 18, wherein the system is used in training.

23. The system of claim 18, wherein the system is used in technical support.

24. The system of claim 18, wherein the system is used in usability studies.
